(19) United States
(12) Patent Application Publication
(10) Pub. No.: US 2023/0327276 A1
(43) Pub. Date: Oct. 12, 2023

(54) BATTERY MODULE ARRANGEMENT, MOTOR VEHICLE, AND METHOD FOR PROVIDING A BATTERY MODULE ARRANGEMENT HAVING A DEGASSING CHANNEL

(71) Applicant: AUDI AG, Ingolstadt (DE)

(72) Inventor: Andreas DEINDL, Kösching (DE)

(73) Assignee: AUDI AG, Ingolstadt (DE)

(21) Appl. No.: 18/187,936

(22) Filed: Mar. 22, 2023

(30) Foreign Application Priority Data
Apr. 4, 2022 (DE) 102022107931.7

(51) Int. Cl. H01M 50/358; H01M 50/209

(52) U.S. Cl. CPC H01M 50/358; H01M 50/209; H01M 2220/20

(57) ABSTRACT

A battery module arrangement for a high-voltage battery of a motor vehicle, which includes a battery module having at least one battery cell, which includes a cell housing having a releasable degassing opening, and includes a a degassing channel, which has a channel opening and is connected to the degassing opening of the at least one battery cell, so that a gas escaping from the battery cell through the degassing opening is at least partially introducible through the assigned channel opening into the degassing channel. The battery cell includes a connecting element for connecting the battery cell to the degassing channel. The connecting element has a tube which is arranged on the cell housing and encloses the degassing opening, and which has a tube end facing away from the cell housing, which protrudes through the assigned channel opening into the degassing channel.

### FIELD

The invention relates to a battery module arrangement for a high-voltage battery of a motor vehicle, wherein the battery module arrangement includes a battery module having at least one battery cell, which comprises a cell housing and an at least releasable degassing opening arranged in an area of the cell housing. The battery module arrangement also includes a degassing channel, which includes a channel opening assigned to the degassing openings, wherein the degassing channel is connected to the degassing opening of the at least one battery cell, so that gas escaping from the battery cell through the degassing opening is introducible at least partially through the assigned channel opening into the degassing channel. A motor vehicle having such a battery module arrangement and a method for providing a battery module arrangement are also part of the invention.

### BACKGROUND

With the ever-increasing spread of traction batteries in vehicles, which are designed in particular as high-voltage batteries, new requirements and laws regarding their safety are also always being published, which deal with, among other things, the behavior of a traction battery in the vehicle in the event of so-called thermal runaway, the thermal runaway of a cell. In some cases, such guidelines state that, for example, after a thermal runaway of a cell has been detected, an evacuation time of at least 5 minutes has to remain for the vehicle occupants, during which there must be no hazard due to fire, for example.

Attempts are currently being made to meet this requirement in a number of ways, which each have diverse disadvantages, however. For example, a different cell chemistry can be used. Thermal runaway can be avoided or mitigated by using a less reactive cell chemistry, such as lithium iron phosphate. However, a disadvantage thus results in terms of energy density, installation space, and weight, which in turn has cost disadvantages. Furthermore, additional cell separating elements can be used. The use of additional cell separating elements usually cannot completely prevent a thermal runaway, but only delay it. Moreover, additional installation space is required between the cells for the cell separating elements, which has a negative influence on energy density, weight, and costs. In addition, a reinforcement of the battery housing or battery cover is also conceivable. In order to withstand the high thermal loads, battery covers made of steel and/or additional fire protection coatings are now often used. These often have disadvantages with respect to weight and costs. In addition, they cannot prevent arcing, which can occur due to the bridging of air gaps and creepage distances in the event of a thermal runaway.

Furthermore, battery modules having battery cells are also known from the prior art, in which gases occurring during a thermal runaway can be discharged from the cells via a degassing channel. For example, DE 10 2009 046 801 A1 describes a battery cell having at least one bursting pressure opening which is connected to a central line for discharging gases. In particular, the gas pressure openings of multiple battery cells can be connected to a common central line. Furthermore, DE 10 2019 102 032 A1 describes an electrochemical energy storage cell, which can also have a bursting membrane, via which a gas of the battery cell occurring in a housing can be discharged in a controlled manner. Furthermore, a gas channel can also be provided, which opens out at such a gas membrane.

Furthermore, DE 10 2019 200 156 A1 describes a battery system having a battery module arranged in a battery housing, having at least one battery cell and at least one degassing channel for degassing the at least one battery cell. In this case, the degassing channel is formed by a structural element which is arranged on a housing cover of the battery housing and which has openings aligned with degassing openings in the battery cells. A seal, not described in detail, can be arranged between a degassing opening of a battery cell and an opening of the degassing channel.

When such degassing channels are provided, the connection of these degassing channels to the battery cells has proven to be particularly difficult. This is because the gases arising during thermal runaway reach extremely high temperatures of greater than 1000° C., due to which, for example, conventional seals between the degassing openings of the battery cells and openings in the degassing channel would immediately melt.

### SUMMARY

The object of the present invention is therefore to provide a battery module arrangement, a motor vehicle, and a method which enable, in the event of a thermal runaway, the largest possible proportion of the gas escaping from a battery cell to be introduced into the degassing channel.

A battery module arrangement according to the invention for a high-voltage battery of a motor vehicle includes a battery module having at least one battery cell, which comprises a cell housing and an at least releasable degassing opening arranged in an area of the cell housing, wherein the battery module arrangement includes a degassing channel which includes a channel opening assigned to the degassing opening. The degassing channel is connected to the degassing opening of the at least one battery cell, so that a gas escaping from the battery cell through the degassing opening is introducible at least partially through the assigned channel opening into the degassing channel. The battery cell also includes a connecting element for connecting the battery cell to the degassing channel, wherein the connecting element includes a tube which is arranged on the cell housing and encloses the degassing opening, in particular in the radial direction, and which has a tube end facing away from the cell housing, which protrudes through the assigned channel opening into the degassing channel.

The proportion of gases introducible into the degassing channel can be increased enormously in case of a thermal runaway due to the tube that protrudes into the degassing channel and is fastened on the cell housing. This in turn makes it possible to increase the safety of the battery module arrangement. This is based on several findings: The gas flow escaping from a battery cell during a thermal runaway primarily represents a particle flow. This particle gas is to be kept away as much as possible from the cell connectors, which electrically connect several battery cells, to avoid short circuits, arcing, and voltage breakdowns. However, if the connection point between the battery cell and the gas channel is not sufficiently sealed, then gas from the cell thus enters the area of these cell connectors in this connection area, which, as described, entails an additional risk potential. Due to the extremely high temperatures of this gas and particle flow, which can range between 1300° C. and 1400° C., conventional plastic seals cannot be used to seal such a connection area, since they would melt in fractions of a second and would not develop any sealing effect. On the other hand, such a degassing channel also cannot simply be glued or welded to the cell housing, since this could result in enormous mechanical stresses and possible damage to the battery cells. This in turn is because battery cells are subject to so-called swelling over the course of their service life and also due to charging. When a battery cell is charged and discharged, it swells and then subsides again, wherein this swelling and subsiding repeats cyclically with each charge or discharge. This charge-related swelling is overlaid with the aging-related swelling, which results in swelling of the battery cells over their service life. The invention, on the other hand, has the great advantages that due to the tube arranged on the cell housing, which extends into the degassing channel, an extremely tight connection of the degassing opening of the battery cell to the degassing channel can be provided, without plastic seals having to be provided for this purpose or the degassing channel having to be adhesively bonded or welded onto the cell housing. Thus, mechanical stresses in the battery cells can be avoided at the same time and at the same time a particularly tight connection of the cell housing to the degassing channel can be provided, which can also withstand extremely high temperatures, since no plastic seals are required.

The degassing channel is preferably made of a very temperature-resistant material, particularly preferably steel. However, it can also be manufactured from aluminum or a glass-fiber-reinforced plastic, preferably having a high glass fiber content, which can be embodied as a dense fabric. Although the degassing channel has to withstand very high temperatures, as described, these high temperatures only occur for a very short time, i.e., for a few seconds, during a thermal event. Accordingly, materials such as aluminum can also be used to form the degassing channel and its components. The same also applies in particular to the connecting element, which is therefore also preferably made of a metal or an alloy, in particular steel.

Furthermore, the at least one battery cell can be formed, for example, as a lithium-ion cell. Other cell chemistries are also conceivable, however, for example lithium iron phosphate. In particular, the measures mentioned at the outset, which do also have disadvantages, such as providing cell separating elements, reinforcing the battery cover, and/or providing fire protection coatings, can still optionally be used within the scope of the invention to further increase safety.

Furthermore, the battery module arrangement can represent a high-voltage battery or comprise a high-voltage battery that includes a number of battery modules, each having multiple battery cells, as will be explained in more detail hereinafter. The cell housing of the battery cell is preferably manufactured from aluminum, but can also be made of another material. The cell housing is preferably manufactured from metal or an alloy. An at least releasable degassing opening of the battery cell is to be understood as an opening that is either closed during normal operation and is only released under certain conditions, for example a certain overpressure and/or a certain temperature inside the cell housing, or also an opening that is permanently released, for example an opening in the cell housing that is not closed even during normal operation. For safety reasons, however, the first variant is preferred, i.e., the degassing opening is closed during normal operation, i.e., under normal, non-critical operating conditions of the battery cell, for example by a bursting membrane, which ruptures if there is a corresponding overpressure inside the battery cell or melts if a certain pressure is exceeded or is destroyed under other circumstances or is otherwise opened, due to which the degassing opening is released. The releasable degassing opening can also be provided, for example, by a pressure relief valve in the cell housing.

Furthermore, the degassing opening can in principle have any desired geometry. It can be made round, for example, or also oval, polygonal, or the like. The same also applies to the channel opening. Preferably, however, both a respective degassing opening and an assigned channel opening are designed having the same geometry, in particular round. In principle, the tube can also have any desired cross-sectional geometry, in particular also polygonal. Here too, however, a round cross-sectional geometry has proven to be particularly advantageous.

In a further advantageous embodiment of the invention, the connecting element has a peripheral flange arranged at the end of the tube, which has a contact surface that abuts a wall area of an inner wall of the degassing channel, wherein the wall area surrounds the assigned channel opening and directly adjoins the assigned channel opening. This peripheral flange can be designed, for example, as a bead or beaded flange. In this case, the flange can also be understood as a tube part, which is provided by forming or bending the tube end (36a) outward in the radial direction. The presently defined tube end on which the flange is arranged relates in this case to the end of the tube which is different from the flange and to which the flange is connected. In other words, this flange can be formed in one piece with the rest of the tube and/or can be connected to the tube in a materially-bonded manner. By providing such a flange or by bending over the tube end (36a) which is inserted into the degassing channel, the tightness can be further increased. It is preferred that this flange only rests on the defined wall area of the inner wall of the degassing channel, but is not adhesively bonded or otherwise fixed to this wall area. This has the great advantage that in particular if the channel opening has a larger diameter than the external diameter of the tube, a relative movement between the tube and the degassing channel is possible in the radial direction, which enables tolerance compensation in the case of the above-mentioned swelling of the battery cell. In this case as well, i.e., when the channel opening is larger than the tube external diameter, the flange makes it possible to cover and thus seal off this intermediate area between the tube and the edge of the channel opening.

Accordingly, it represents another particularly advantageous embodiment of the invention if the tube has a smaller external diameter in at least one first direction than the assigned channel opening, so that the tube is movable in the first direction in relation to the degassing channel. This advantageously enables tolerance compensation, as a result of which the battery cell can nevertheless be connected very tightly to the degassing channel by the provided flange. The mentioned first direction preferably extends radially in relation to the tube, i.e., it extends perpendicular to a tube axis, which represents an imaginary, central axis of rotation of the tube. Particularly preferably, the tube has a smaller external diameter in two directions or in each direction perpendicular to the tube axis than the assigned channel opening. A tolerance compensation is thus made possible in these two directions, in particular in all directions. In addition, since the flange is not adhesively bonded or welded to the degassing channel, tolerance compensation in the direction of the tube axis is also possible in principle. In this direction, however, the above-described swelling effect in a battery cell is not noticeable or is barely noticeable.

In a further, very advantageous embodiment of the invention, the degassing channel includes an at least partially cylindrical collar which protrudes into the interior of the degassing channel and radially delimits the channel opening, which collar is arranged concentrically to the tube, wherein the collar has a collar end region, and wherein the connecting element has a terminating element which is arranged in the tube end and which is connected to the collar end area by a folded joint. Such a collar can also be provided in the form of a tube. This collar can, for example, extend annularly around the channel opening in the form of a thin metal sheet. In the simplest case, the connecting element, which is arranged at the tube end and can be formed in one piece with the tube end, can be turned inside out around the collar end area. However, the terminating element can also be bent or turned inside out radially outward one or more times together with the collar end area, as is typical for folded joints. The collar end area can therefore be turned inside out or bent or folded over one or more times together with the terminating element of the tube, that is to say a corresponding tube end area, so to speak.

In this case as well, a particularly tight connection of the cell housing to the degassing channel can be provided, which does not require any adhesive bonding or welding. In addition, tolerance compensation can also again be provided here, in particular if at least the connecting element is designed having correspondingly thin walls. The collar can also be formed, for example, from steel, another metal, or a lacquering or from glass-fiber-reinforced plastic.

It is therefore a further advantageous embodiment of the invention if at least the connecting element is designed having such thin walls that at least part of the tube is movable relative to the degassing channel. In addition, the above-described collar can also be designed having correspondingly thin walls. A thin-walled design is preferably to be understood as wall thicknesses of less than one millimeter, i.e., in the micrometer range.

In this case, the channel opening also does not have to be made significantly larger than the degassing opening or the tube. The respective tube parts, i.e., the tube and also the collar, can shift and bend in relation to one another, so that in this way tolerance compensation can advantageously be provided when the battery cell swells.

With the above-described variants, it is also preferred that the tube does not protrude particularly far into the degassing channel. In the first case, in which a flange is arranged at the tube end and rests against a wall area of the inner wall of the degassing channel, it is sufficient, for example, if the tube protrudes into the degassing channel by the thickness of the tube wall, since this is sufficient for flanging to provide the flange. Also in the second case, in which a folded joint is provided between the collar end area and the terminating element of the tube, it is preferred that the tube protrudes at most a few millimeters into the degassing channel in the final state. As a result, the flow resistance in the degassing channel can advantageously be reduced to a minimum.

In a further advantageous embodiment of the invention, the degassing channel has a lower channel shell, in which the associated channel opening is arranged, and an upper channel shell, which is arranged on the lower channel shell and faces away from the battery module. The lower channel shell and the upper channel shell can, for example, be connected to one another in any desired manner, for example clipped, folded, plugged, or welded. The two-part design of the degassing channel or the multi-part design has the great advantage that it enormously simplifies the assembly of the battery module arrangement. As described, the tube arranged on the cell housing is preferably connected to the cell housing in a materially-bonded manner. In order to provide the tightest possible connection between this tube and the lower shell of the degassing channel, this tube can, for example, simply be pushed through the assigned channel opening in the lower shell of the degassing channel. The protruding tube part can then, for example, simply be flanged or folded over with the described collar end area. This procedure is particularly easy to carry out if the upper channel shell is not placed on the lower channel shell at this time. This is because this provides significantly better accessibility. After this sealing procedure, whether by flanging or folding, the upper channel shell can finally be placed on the lower channel shell and connected thereto.

In a further advantageous embodiment of the invention, the battery module arrangement includes multiple battery modules, in particular arranged in a row, each having at least one battery cell, which include respective cell housings, degassing openings, and connecting elements for connecting the respective battery cells to the degassing channel, wherein the degassing channel includes multiple channel openings assigned to a respective degassing opening. In other words, the battery module can include multiple battery cells, which can be designed as described for the at least one battery cell and can be connected to the degassing channel in a very analogous manner. Multiple battery cells can therefore advantageously be coupled to the same degassing channel, in particular in accordance with the variants already described. For this purpose, it is also advantageous if, for example, the degassing openings of the multiple battery cells of the same battery module are arranged along a line. This is because this enables the degassing channel to be formed in a straight line, which can be provided in a particularly simple manner.

In addition, the degassing channel can be coupled not only to multiple battery cells of the same battery module, but also to the battery cells of different battery modules. Accordingly, it represents a further advantageous embodiment of the invention, if the battery module arrangement includes multiple battery modules, in particular arranged in a row, each having at least one battery cell, which include respective cell housings, degassing openings, and connecting elements for connecting the respective battery cells to the degassing channel, wherein the degassing channel includes multiple channel openings assigned to a respective degassing opening. The degassing channel can therefore extend over multiple battery modules arranged adjacent to one another. This enables a particularly simple and efficient design of the degassing channel. In order to simplify the assembly, the above-described lower channel shell described above can also be formed in multiple pieces, for example, wherein a respective lower shell piece is assigned to a respective battery module. When assembling the battery, the respective lower shell parts can be connected to one another, for example plugged into one another, welded together, clipped together, or connected in another way. The upper channel shell can also be formed in multiple pieces or alternatively also in one piece for multiple battery modules. This has the background that the upper shell is placed on the lower shell after the connection and sealing process for connecting the cell housing. This can take place, for example, in a last step before the housing cover of a battery housing, in which the battery modules can be accommodated, is finally put on.

Above all, it is particularly advantageous that the degassing channel, and in particular the above-described upper channel shell, is different from a housing cover. This has the great advantage that only the degassing channel can be made correspondingly robust and heat-resistant, and can be made of steel, for example, while other battery components, such as the battery housing, in particular the housing cover, can be made less robust, for example thin-walled and from aluminum, without a safety risk arising from this. As a result, weight and costs can be saved overall.

As described, the battery module arrangement can also include a battery housing in which the at least one battery module is accommodated. The battery housing can, for example, comprise a lower housing shell and a cover, wherein the battery modules and the degassing channel are preferably inserted into the battery housing in such a way that the degassing channel faces toward the housing cover.

The gas arising during a thermal runaway can be guided through such a degassing channel and discharged deliberately from the battery system, without live areas within the battery being contaminated with the gas. As a result, air gaps and creepage distances cannot be bridged by the harmful gas during cell degassing.

In addition, the battery module arrangement can provide a high-voltage battery for a motor vehicle, which preferably functions as a traction battery for an electric or hybrid vehicle.

Furthermore, the invention also relates to a motor vehicle having a battery module arrangement according to the invention or one of its designs. The advantages mentioned for the battery module arrangement according to the invention and its designs thus apply similarly to the motor vehicle according to the invention.

The motor vehicle according to the invention is preferably designed as an automobile, in particular as a passenger car or truck, or as a passenger bus or motorcycle.

Furthermore, the invention also relates to a method for providing a battery module arrangement for a high-voltage battery of a motor vehicle, wherein a battery module having at least one battery cell is provided, which comprises a cell housing and an at least releasable degassing opening arranged in a region of the cell housing, wherein a degassing channel is provided, which has a channel opening assigned to the degassing opening, and wherein the degassing channel is connected to the degassing opening of the at least one battery cell, so that a gas escaping from the battery cell through the degassing opening is introducible at least partially through the assigned channel opening into the degassing channel. The battery cell is provided with a connecting element for connecting the battery cell to the degassing channel, which has a tube which is arranged on the cell housing and encloses the degassing opening and which has a tube end facing away from a cell housing, wherein when the degassing channel is connected to the degassing opening, the tube end is introduced through the assigned channel opening into the degassing channel.

The advantages mentioned for the battery module arrangement according to the invention and its embodiments thus apply similarly to the method according to the invention.

The invention also includes refinements of the method according to the invention, which have features as have already been described in conjunction with the refinements of the battery module arrangement according to the invention. For this reason, the corresponding refinements of the method according to the invention are not described again here.

The invention also comprises the combinations of the features of the described embodiments. The invention also includes implementations that each have a combination of the features of several of the described embodiments, provided that the embodiments were not described as mutually exclusive.

### BRIEF DESCRIPTION OF THE FIGURES

Exemplary embodiments of the invention are described hereinafter. In the figures:

FIG. 1 shows a schematic cross-sectional illustration through a battery module arrangement according to a first exemplary embodiment of the invention;

FIG. 2 shows a schematic cross-sectional illustration of a battery module arrangement according to a second embodiment of the invention;

FIG. 3 shows a perspective illustration of a battery module arrangement, according to which multiple battery cells of a battery module are connected to the same degassing channel, according to an exemplary embodiment of the invention;

FIG. 4 shows a schematic and perspective illustration of the battery module arrangement from FIG. 3 having an upper channel shell placed on a lower shell of the degassing channel, according to an exemplary embodiment of the invention; and

FIG. 5 shows a schematic and perspective illustration of a battery module arrangement having multiple battery modules connected to a degassing channel, according to a further exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those represented. Furthermore, the described embodiments can also be supplemented by further features of the invention as already described.

In the figures, the same reference numerals respectively designate elements that have the same function.

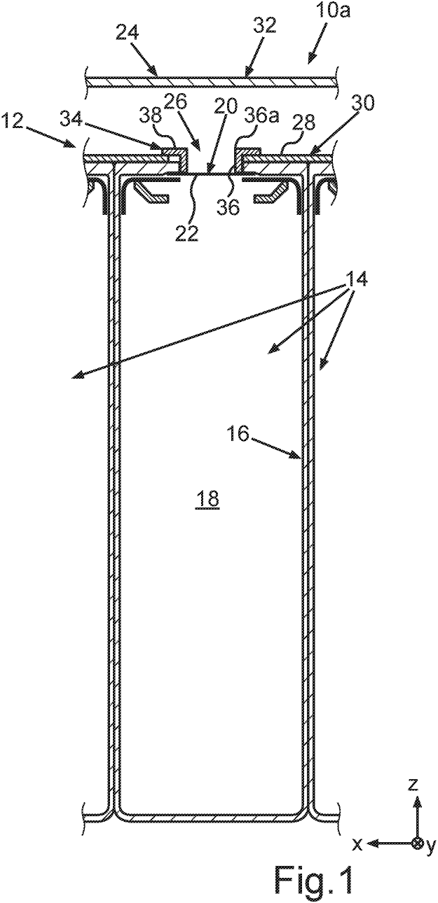

FIG. 1 shows a schematic illustration of a battery module arrangement 10a according to a first exemplary embodiment of the invention. The battery module arrangement 10a includes a battery module 12 having multiple battery cells 14, which can be designed as lithium-ion cells, for example, and are arranged in a row, here in the x direction shown, adjacent to one another. In the present example, which is illustrated in FIG. 1, only a single battery cell 14 is shown as a whole, but the other battery cells can be designed in a completely analogous manner. Such a battery cell 14 includes a cell housing 16 which surrounds a cell interior 18. The battery cells 14 shown here are also designed as prismatic battery cells. However, the invention can also be applied in the same way, for example, to battery cells 14 designed as round cells. A respective battery cell 14 moreover includes a releasable degassing opening 20, which in the present examples is closed by a bursting membrane 22, which ruptures at a certain overpressure within the battery cells 14 and thus releases the opening 20, from which gases can then accordingly escape.

In particular in the event of a thermal runaway, the battery cells 14 will outgas, resulting in very high temperatures. The extremely hot gases escaping from the battery cells 14 are therefore to be discharged as safely as possible, in particular in such a way that no live areas, for example cell connector areas, within the battery or the battery module arrangement 10a are contaminated with the gas. Otherwise air gaps and creepage distances could be bridged by the harmful gas during cell degassing. This is now advantageously accomplished by providing a degassing channel 24 as part of the battery module arrangement 10a. Such a degassing channel 24 has a channel opening 26 corresponding to the degassing opening 20, which can be formed, for example, as a hole in the channel wall 28, in particular the channel wall 28 of the degassing channel 24 facing toward the battery cell 14. The degassing channel 24 can in particular be formed in multiple parts and can, for example, comprise a lower channel shell 30 and an upper channel shell 32 which are connected to one another, for example are welded to one another, clipped, or connected to one another in another way. The lower channel shell 30 can, for example, correspondingly comprise the above-mentioned channel wall 28 in which the channel opening 26 corresponding to the degassing opening 20 is arranged. In particular, multiple channel openings 26 arranged in a row, for example, can be arranged in this channel wall 28, which correspond to the respective degassing openings 20 of the battery cells 14 arranged in the row.

In order to enable as large a part of the gases as possible to be introduced into the degassing channel 24 from the battery cell 14 in case of a thermal event, it is advantageous for the degassing opening 20 to be connected to the channel opening 26 as tightly as possible. However, conventional seals are not suitable for this purpose because they would immediately melt and burn at the extremely high temperatures. It is also to be considered that the battery cells 14 are subject to swelling due to charging and also over the course of their service life, which results in cyclical inflation and contraction of the cells, in particular of the cell housing 16, above all in the x direction shown here. Correspondingly, in order to avoid mechanical stresses and damage to the cells 14, a certain tolerance compensation option is also to be provided between the cell housing 16 and the degassing channel 24. This can be implemented in greatly differing ways. In general, the battery cell 14 has a connecting element 34 which comprises a tube 36 which is arranged on the cell housing 16. This tube 36 encloses the degassing opening 20 of the battery cell 14. Furthermore, this tube has a tube end 36a which faces away from the cell housing 16 and protrudes into the degassing channel 24. This has the advantage that gas escaping from the battery cell 14 through the degassing opening 20 can only reach between the degassing channel 24 and the cell housing 16 with difficulty. The largest part of the escaping gas is advantageously conducted directly into the degassing channel 24 via this tube 36. In particular, the escaping gas can thus be conducted completely into this degassing channel 24. There are multiple options to further increase the tightness of this connection point. These will now be explained in more detail hereinafter:

The first option is shown in FIG. 1. A flange 38 adjoins the tube 36, in particular the tube end 36a. This can also be provided, for example, as a beaded flange 38, which was provided by flanging the original tube end area. In other words, a tube end area of the tube 36 can be bent outwards during battery assembly, that is to say outwards in the radial direction, by flanging and thus provide this flange 38. Furthermore, this flange 38 is designed corresponding to the geometry of the channel opening 26 in such a way that it partially abuts an inner wall of the degassing channel 24, in particular on the inner area of the wall 28. In addition, it is preferred that the channel opening 26 has a larger diameter than the external diameter of the tube 36, since this allows the above-mentioned tolerance compensation to be provided. In other words, the tube 36 can move relative to the degassing channel 24, for example in the x and/or y direction shown here. At the same time, the flange 38 ensures that the degassing opening 20 is also sealed off from the channel opening 26 despite this movement. In this way, the degassing openings 20 of the individual cells 14 within the cell module 12 can advantageously be tightly connected to the lower side 30 of the degassing channel 24. To compensate for tolerances and to prevent swelling, the channel openings 26 can thus be made larger, but a nearly tight connection can still be produced by a broad overlap of the flanging, i.e., by the described flange 38 of the cell degassing tube 36. This degassing tube 36 can also be flanged onto the bursting opening, that is to say the degassing opening 20. This tube 36, that is to say including the flange 38 directly adjoining thereon, is preferably as temperature-resistant as possible and is tightly connected to the channel 24 as described. The degassing channel 24 itself is also preferably made of a high-temperature-resistant material, for example steel or another high-temperature-resistant material. Alternatively or additionally, the degassing channel 24 can also be formed from a material that is temperature-resistant due to a coating.

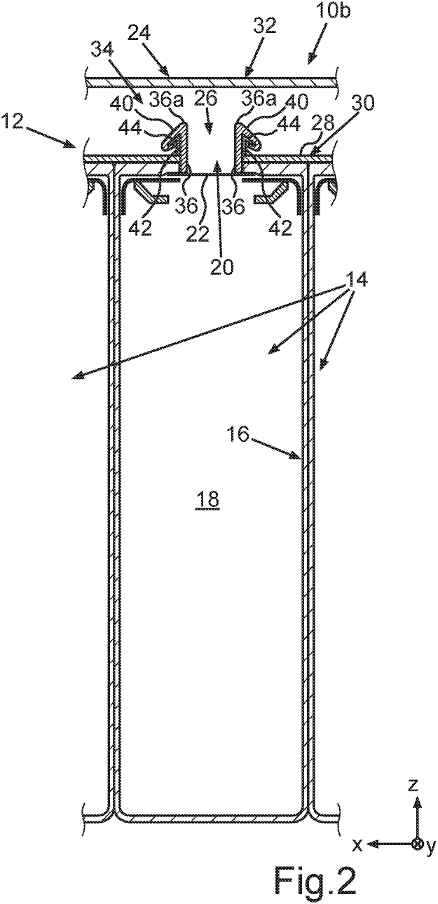

FIG. 2 shows another example of a battery module arrangement 10b in a cross section, wherein this battery module arrangement 10b can be designed in the same way as described above, except for the differences described hereinafter: In this example, the connection of the cell housing 16 to the degassing channel 24 is designed somewhat differently. In this case as well, the battery cell 14 again has a connecting element 34 which comprises a tube 36 having a tube end 36a facing away from the cell housing 16. In this example, a terminating element 40 of the connecting element 34 now adjoins this tube end 36a. Furthermore, in this example, the degassing channel 24 also has a collar 42, surrounding the channel opening 26, having a collar end area 44. The collar end area 44 is also connected to the terminating element 40 by a folded joint. To provide this arrangement, for example, the tube 36 can be inserted through the channel opening 26 and is coaxial with the mentioned collar 42. The collar end, which is provided by the collar end area 44, and the end adjoining the tube 36, which is presently referred to as the terminating element 40, are then folded, that is to say bent or turned inside out one or more times in relation to one another. A particularly tight connection between the cell housing 16 and the degassing channel 24 can also be provided in this way. Furthermore, it is preferred in this case that the connecting element 34 as well as the collar 42 having its collar end area 44 are designed having thin walls. In particular, these components can be provided with a wall thickness of less than 1 mm. This in turn advantageously enables tolerance compensation, since the tube 36 can be displaced relative to the degassing channel 24 at least in some areas by bending. In this way as well, on the one hand a tight connection can be provided between the battery cell 14 and the degassing channel 24 and at the same time a tolerance compensation can be provided for swelling effects.

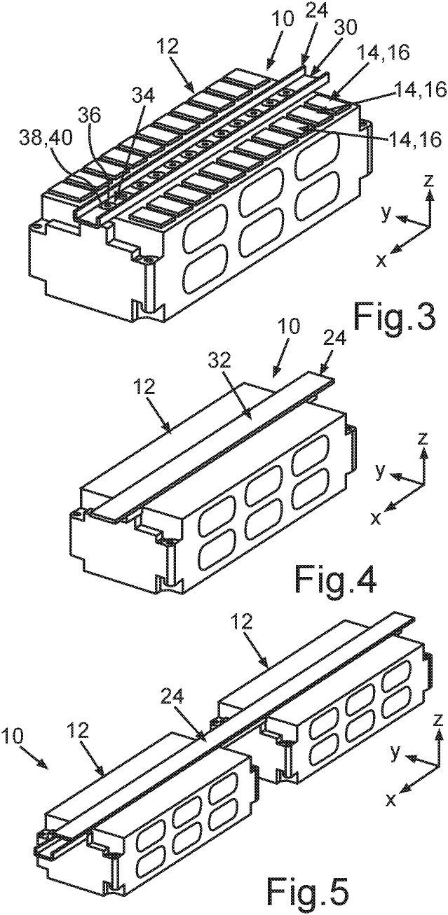

FIG. 3 shows a schematic and perspective illustration of a battery module arrangement 10, which can be designed, for example, as described for FIG. 1 or FIG. 2. In this example, the battery module 12 also comprises multiple battery cells 14 which are arranged adjacent to one another in the x direction, so that their respective releasable degassing openings 20 lie on one line. In this example, only the lower shell 30 of the degassing channel 24 is shown, which extends beyond the respective degassing openings 20 of the battery cells 14. Also shown are the respective tubes 36 that are pushed through the channel openings 26 and are tightly connected to the lower channel shell 30 by flanging or folding. For reasons of clarity, only three battery cells 14 having their cell housings 16 and only one connecting element 34 having its tube 36 and flange 38 or terminating element 40 arranged thereon are provided with a reference numeral in FIG. 3.

FIG. 4 shows a perspective illustration of the battery module 12, in particular the battery module arrangement 10 from FIG. 3 having the upper channel shell 32 placed on the lower channel shell 30.

FIG. 5 shows a schematic and perspective illustration of a battery module arrangement 10 having multiple battery modules 12 which are connected to a common degassing channel 24. The battery modules 12 and the degassing channel 24 can be designed as previously described. The cover of the degassing channel 24, i.e., the upper channel shell 32, is preferably sealed off from the lower channel shell 30. This sealing can also be implemented by welding, for example. However, other connection options already mentioned are also conceivable. In the battery system, the degassing channels 24 or the individual parts of the degassing channels 24 of multiple cell modules 12 can be connected to one another, as illustrated in FIG. 5, and the gas can ultimately be conducted to the exterior or into a buffer container at the channel end of the degassing channel 24. The connection between the individual degassing channel sections can be implemented, for example, via a toothing of the respective sections or via a connecting piece. Other connection mechanisms are also conceivable here. For example, the upper channel shell 32 for multiple battery modules 12 can also be designed in one piece.

Overall, the examples show how the invention can provide a battery cell module having a degassing channel, which allows gases escaping from the battery cells in the event of a thermal runaway to be discharged as safely as possible by introducing a tube arranged on the cell housings into the degassing channel, by which a seal having tolerance compensation option can be provided.

1. A battery module arrangement for a high-voltage battery of a motor vehicle, comprising: a battery module having at least one battery cell, which comprises a cell housing and an at least releasable degassing opening arranged in an area of the cell housing, wherein the battery module arrangement includes a degassing channel, which has a channel opening assigned to the degassing opening, wherein the degassing channel is connected to the degassing opening of the at least one battery cell, so that a gas escaping from the battery cell through the degassing opening is at least partially introducible through the assigned channel opening into the degassing channel,
wherein the battery cell includes a connecting element for connecting the battery cell to the degassing channel, wherein the connecting element has a tube which is arranged on the cell housing and encloses the degassing opening, and which has a tube end facing away from the cell housing, which protrudes through the assigned channel opening into the degassing channel.

2. The battery module arrangement as claimed in claim 1, wherein the connecting element has a peripheral flange arranged at the tube end, which has a contact surface which abuts a wall area of an inner wall of the degassing channel, wherein the wall area surrounds the assigned channel opening and directly adjoins the assigned channel opening.

3. The battery module arrangement as claimed in claim 1, wherein the tube has a smaller external diameter in at least one first direction than the associated channel opening, so that the tube is movable in the first direction in relation to the degassing channel.

4. The battery module arrangement as claimed in claim 1, wherein the degassing channel includes an at least partially cylindrical collar which protrudes into an interior of the degassing channel and radially delimits the channel opening, which collar is arranged concentrically to the tube, wherein the collar includes a collar end area, wherein the connecting element includes a terminating element which is arranged at the tube end and which is connected to the collar end area by a folded joint.

5. The battery module arrangement as claimed claim 1, wherein at least the connecting element is designed having such thin walls that at least part of the tube is movable relative to the degassing channel.

6. The battery module arrangement as claimed in claim 1, wherein the degassing channel includes a lower channel shell in which the associated channel opening is arranged, and an upper channel shell which is arranged on the lower channel shell and faces away from the battery module.

7. The battery module arrangement as claimed in claim 1, wherein the battery module includes multiple battery cells arranged in a row, which include the respective cell housings, degassing openings, and connecting elements for connecting the respective battery cells to the degassing channel, wherein the degassing channel includes multiple channel openings assigned to a respective degassing opening.

8. The battery module arrangement as claimed in claim 1, wherein the battery module arrangement includes multiple modules, in particular arranged in a row, each having at least one battery cell, which include the respective cell housings, degassing openings, and connecting elements for connecting the respective battery cells to the degassing channel, wherein the degassing channel includes multiple channel openings assigned to a respective degassing opening.

9. A motor vehicle having a battery module arrangement as claimed in claim 1.

10. A method for providing a battery module arrangement for a high-voltage battery of a motor vehicle, wherein
a battery module having at least one battery cell is provided, which comprises a cell housing and an at least releasable degassing opening arranged in an area of the cell housing;
a degassing channel is provided, which includes a channel opening assigned to the degassing opening; and
the degassing channel is connected to the degassing opening of the at least one battery cell, so that a gas escaping from the battery cell through the degassing opening is introducible at least partially through the assigned channel opening into the degassing channel;
wherein the battery cell is provided with a connecting element for connecting the battery cell to the degassing channel, which connecting element has a tube which is arranged on the cell housing and encloses the degassing opening, and which has a tube end facing away from the cell housing, wherein when the degassing channel is connected to the degassing opening, the tube end is introduced through the assigned channel opening into the degassing channel.

11. The battery module arrangement as claimed in claim 2, wherein the tube has a smaller external diameter in at least one first direction than the associated channel opening, so that the tube is movable in the first direction in relation to the degassing channel.

12. The battery module arrangement as claimed claim 2, wherein at least the connecting element is designed having such thin walls that at least part of the tube is movable relative to the degassing channel.

13. The battery module arrangement as claimed claim 3, wherein at least the connecting element is designed having such thin walls that at least part of the tube is movable relative to the degassing channel.

14. The battery module arrangement as claimed claim 4, wherein at least the connecting element is designed having such thin walls that at least part of the tube is movable relative to the degassing channel.

15. The battery module arrangement as claimed in claim 2, wherein the degassing channel includes a lower channel shell in which the associated channel opening is arranged, and an upper channel shell which is arranged on the lower channel shell and faces away from the battery module.

16. The battery module arrangement as claimed in claim 3, wherein the degassing channel includes a lower channel shell in which the associated channel opening is arranged, and an upper channel shell which is arranged on the lower channel shell and faces away from the battery module.

17. The battery module arrangement as claimed in claim 4, wherein the degassing channel includes a lower channel shell in which the associated channel opening is arranged, and an upper channel shell which is arranged on the lower channel shell and faces away from the battery module.

18. The battery module arrangement as claimed in claim 5, wherein the degassing channel includes a lower channel shell in which the associated channel opening is arranged, and an upper channel shell which is arranged on the lower channel shell and faces away from the battery module.

19. The battery module arrangement as claimed in claim 2, wherein the battery module includes multiple battery cells arranged in a row, which include the respective cell housings, degassing openings, and connecting elements for connecting the respective battery cells to the degassing channel, wherein the degassing channel includes multiple channel openings assigned to a respective degassing opening .

20. The battery module arrangement as claimed in claim 3, wherein the battery module includes multiple battery cells arranged in a row, which include the respective cell housings, degassing openings, and connecting elements for connecting the respective battery cells to the degassing channel, wherein the degassing channel includes multiple channel openings assigned to a respective degassing opening.
